(19) United States
(12) Patent Application Publication
(10) Pub. No.: US 2021/0199373 A1
(43) Pub. Date: Jul. 1, 2021

(54) HOUSEHOLD APPLIANCE DEVICE, IN PARTICULAR HOUSEHOLD REFRIGERATION APPLIANCE DEVICE

(71) Applicant: BSH HAUSGERAETE GMBH, MUENCHEN (DE)

(72) Inventor: DIETER URBAN, PFAFFENHOFEN (DE)

(21) Appl. No.: 16/754,770

(22) PCT Filed: Nov. 23, 2018
(86) PCT No.: PCT/EP2018/082369

§ 371 Date: Apr. 9, 2020

Related U.S. Application Data
(63) Continuation of application No. PCT/EP2018/082369, filed on Nov. 23, 2018.

(30) Foreign Application Priority Data
Dec. 28, 2017 (DE) 102017223840

(51) Int. Cl. F25D 29/00; F25D 27/00

(52) U.S. Cl. CPC F25D 29/005; G01N 21/31; F25D 27/005

(57) ABSTRACT

An economical household appliance device, in particular a household refrigerator device, includes at least one storage space and at least one food inspection or monitoring device for determining at least one food parameter of at least one item of food in the storage space by spectral analysis. At least one illumination device illuminates at least one part of the storage space in order to determine a food parameter. The food inspection or monitoring device carries out a spectral analysis of an item of food at least by providing a wavelength-selective illumination by using the at least one illumination device. The illumination device has multiple LEDs disposed in an array, which together emit electromagnetic radiation in a wavelength band of 250 nm to 1200 nm. A food inspection or monitoring device and a method for inspecting or monitoring food are also provided.

The invention is based on a household appliance device, in particular a household refrigeration appliance device according to the preamble of claim 1.

The document US 2008/0138841 A1 already discloses a monitoring system, which has a sensing means which can be operated in order to detect a predetermined microorganism in a predetermined environment and a user interface. The sensing means comprises elements which are provided to emit UV light and to measure resulting emissions from microorganisms. The user interface is actively connected to the sensing means and can be actuated so that it generates a warning or an alarm as a response to detecting a predetermined microorganism by means of the sensing means.

The German patent application DE 10 2013 211 097 A1 discloses a refrigeration appliance which comprises a camera module for detecting first image data of refrigerated goods at a first point in time and second image data of refrigerated goods at a second point in time and a freshness determination apparatus for determining a freshness of the refrigerated goods on the basis of the first image data and the second image data.

The object of the invention consists in particular in providing a generic device with improved properties with respect to a cost saving. The object is achieved in accordance with the invention by the features of claim 1, while advantageous embodiments and developments of the invention can be taken from the subclaims.

The invention is based on a household appliance device, in particular a household refrigeration appliance device, with at least one storage space and with at least one food inspection device which is provided at least by means of a spectral analysis to determine at least one food parameter of at least one food arranged in the storage space and to this end comprises at least one illumination means which is provided at least for determining a food parameter in order to illuminate at least one part of the storage space.

The food inspection device is provided at least by means of a wavelength-selective illumination using the at least one illumination means to carry out a spectral analysis of a food. A “household appliance device” should in particular be understood to mean at least one part, in particular a sub-assembly, of a household appliance, wherein the household appliance has at least one useable space which is provided at least partially to store food. The usable space is preferably embodied to be closeable, wherein in a closed state of the usable space no light is able to penetrate the interior of the usable space preferably from outside of the usable space. A “household refrigeration appliance device” in this context is to be understood in particular to mean at least one part, in particular a sub-assembly, of a household refrigeration appliance. In particular, the household refrigeration appliance device can also comprise the entire household refrigeration appliance. The household refrigeration appliance is particularly preferably embodied as a refrigerator and/or freezer, such as in particular as a domestic refrigerator, deep freezer, upright freezer, chest freezer, fridge-freezer and/or wine storage cabinet. In particular, the household refrigeration appliance device here comprises at least one appliance body, which delimits and/or defines in particular an interior, preferably at least a usable space embodied as a refrigeration compartment and in particular has an access opening. The household refrigeration appliance has an appliance closing element, with which the usable space can be closed. The appliance closing element could be embodied here in particular at least partially as an appliance drawer and in particular be embodied to be linearly movable. The appliance closing element is advantageously embodied as an appliance flap and/or preferably as an appliance door and is pivotably mounted preferably about a pivot axis, in particular about a horizontal axis and/or preferably about a vertical axis, in particular with respect to a setup position and/or an installation position, in particular relative to the appliance carcass. A “refrigeration compartment” should in particular be understood to mean a refrigerating zone, in which food can be stored at temperatures of 1 to 15 degrees Celsius. It would essentially also be conceivable for the refrigeration compartment to be embodied as a freezer compartment, in which food can be frozen and stored at temperatures of −25 degrees to −5 degrees Celsius. A “food inspection device” should in particular be understood to mean a device for inspecting food stored in a refrigeration appliance and detects at least one state of at least one food. The food inspection device is provided in particular to inspect a freshness and/or a category of a food. The food inspection device is provided in particular to determine at least one food parameter, by means of which conclusions can be drawn with respect to a level of maturity, a level of ripeness, a category and/or ingredients of a food. The food inspection device is provided in particular to inspect unpackaged food or food only packaged with a thin film. “Spectral analysis” is to be understood here to mean in particular an analysis of a spectrum of electromagnetic radiation reflected and/or absorbed by an element for determining a chemical composition of the element. With the spectral analysis, electromagnetic radiation, in particular electromagnetic radiation reflected by an element to be tested, such as in particular a food, is detected and the spectrum of the detected electromagnetic radiation is examined with respect to an intensity in the different wavelength ranges. A “hyperspectral analysis” should in particular be understood to mean a spectral analysis, in which at least 25 wavelengths are recorded and analyzed in a wavelength range of 100 nm. A “multispectral analysis” should in particular be understood to mean a spectral analysis, in which at least 8 wavelengths are recorded and analyzed in a wavelength range of 100 nm. A “food parameter” should be understood to mean in particular a parameter which reproduces a state and/or a category of a food. A food parameter is formed in particular from a chemical composition of a food or a chemical composition of substances present on the food. A “wavelength-selective illumination” should in particular be understood to mean an illumination with electromagnetic radiation, in which an element to be illuminated, such as in particular a food to be inspected, is irradiated with electromagnetic radiation which has a wavelength band which only corresponds to part of a possible wavelength band which can be generated with the illumination means. With the wavelength-selective illumination, the element to be illuminated is illuminated in a first illumination period with electromagnetic radiation with a first wavelength band and in a further illumination period with electromagnetic radiation with another wavelength band. It is conceivable here for the electromagnetic radiations with the different wavelength bands to have an equally sized emission spectrum or for the electromagnetic radiations with the different wavelength bands to have emission spectra of different sizes. An “illumination means” should be understood to mean in particular an element or an arrangement of elements which are provided to output electromagnetic radiation in an activated state. The illumination means is preferably provided in particular to generate electromagnetic radiation in a wavelength range of 200 nm to 1200 nm. It would essentially also be conceivable for the illumination means to be provided to emit electromagnetic radiation with a wider wavelength range. In particular, it is conceivable here for the illumination means to be provided in order to output electromagnetic radiation in the ultraviolet wavelength range of 10 nm to 380 nm, electromagnetic radiation in the medial infrared wavelength range of 1 μm to 10 μm, electromagnetic radiation in the far infrared wavelength range of 20 μm to 350 μm and/or electromagnetic radiation in the terahertz wavelength range of 350 μm to 1 mm. “Provided” is to be understood in particular as meaning especially programmed, configured and/or equipped. The fact that an object is provided for a specific function is to be understood in particular as meaning that the object fulfills and/or carries out this specific function in at least one application and/or operating state. By means of the inventive embodiment, a cost-effective and customary photodetector element can be used particularly advantageously to carry out a spectral analysis, in particular a multi- or hyperspectral analysis, as a result of which a cost-effective household appliance device can in particular be provided.

Furthermore, it is proposed that the food inspection device be provided to determine at least one food parameter by means of the at least one illumination means at least to illuminate with electromagnetic radiation in a defined wavelength band of at most 100 nm in at least one exposure period. “Electromagnetic radiation in a defined wavelength band of at most 100 nm” should in particular be understood to mean electromagnetic radiation, the minimal wavelength and maximum wavelength of which has a spacing of at most 100 nm, preferably of at most 50 nm and in a particularly advantageous embodiment of at most 20 nm. As a result the food inspection device can determine a food parameter of a food particularly advantageously.

It is further proposed that the illumination means has at least two LEDs arranged in an array. An “array” is to be understood in particular to mean an arrangement of elements of the same kind, such as in particular LEDs in a defined range. The LEDs arranged in an array are distributed here preferably uniformly across a surface of the illumination means.

The illumination means has a number of LEDs arranged in an array, which together are provided to output electromagnetic radiation in a wavelength band of 250 nm to 1200 nm. The fact that the LEDs are provided together in order to output electromagnetic radiation in a wavelength band of 250 nm to 1200 nm should in particular be understood here to mean that electromagnetic radiation of all LEDs in an activated state fills the entire spectrum of 250 nm to 1200 nm. As a result, electromagnetic radiation which is particularly advantageous for a spectral analysis can be generated by means of the illumination means and covers a broad wavelength spectrum.

Furthermore, it is proposed that the illumination means has a number of LEDs arranged in an array, which are each provided to have electromagnetic radiation with an emission spectrum of at most 50 nm. An “emission spectrum of at most 50 nm” should in particular be understood to mean that electromagnetic radiation has a minimum wavelength which has a spacing of at most 50 nm, preferably of at most 35 nm and in a particularly advantageous embodiment of at most 20 nm relative to its maximum wavelength. As a result, the LEDs of the illumination means can achieve a particularly advantageous wavelength resolution for emittable electromagnetic radiation.

Furthermore, it is proposed that the illumination means has a number of LEDs arranged in an array which can be controlled at least partially independently of one another. “At least partially independently” should be understood here to mean that at least LEDs, which are provided to emit electromagnetic radiations with different wavelengths, can be switched on or off independently of one another. As a result, a wavelength-selective illumination can take place particularly easily by means of the illumination means.

Moreover, it is proposed that the illumination means has a number of LEDs arranged in an array, wherein two LEDs which are adjacent in terms of wavelength range have a wavelength spacing of at most 100 nm. A “wavelength spacing between two LEDs” should be understood here to mean in particular a spacing between peak wavelengths of the two LEDs. “LEDs which are adjacent in terms of wavelength range” should in particular be understood to mean two LEDs of the array, the wavelength band of the outputtable electromagnetic radiation of which has in each case the smallest spacing from one another. In this case, “adjacent” should not necessarily be understood in particular to mean adjacent to one another, when viewed spatially. As a result, the illumination means can be provided with a particularly advantageous wavelength resolution.

It is further proposed that the food inspection device comprises at least one sensor device with at least one photodetector element, which is at least provided to determine a food parameter, in order to receive at least one electromagnetic radiation from the detection range in the usable space. A “photodetector element” should be understood here in particular to mean a sensor element which converts in particular a detected electromagnetic radiation, in particular electromagnetic radiation in a wavelength range of 300 nm to 1200 nm, into a corresponding electric or electronic sensor signal. It would essentially also be conceivable for the photodetector element to be provided to detect electromagnetic radiation in a broader wavelength range and to convert the same into a sensor signal. It is particularly conceivable for the photodetector element to be provided to detect electromagnetic radiation in the ultraviolet wavelength range of 10 nm to 380 nm, electromagnetic radiation in the medial infrared wavelength range of 1 μm to 10 μm, electromagnetic radiation in the far infrared wavelength range of 20 μm to 350 μm and/or electromagnetic radiation in the terahertz radiation wavelength range of 350 μm to 1 mm and to convert the same into a sensor signal. A “detection range” should in particular be understood to mean a range which can be detected by a sensor element, in particular the photodetector element. As a result the food inspection device can be embodied in an especially simple manner.

Furthermore, it is proposed that the photodetector element is embodied as an image sensor element which is provided at least to detect at least one image. An “image sensor element” should in particular be understood to mean a sensor element which detects a plurality of pixels from a detection range and can generate an image herefrom. An image sensor element is preferably embodied in particular as a CMOS or CCD image sensor. It is essentially also conceivable for the image sensor element to be embodied as another image sensor element which appears meaningful to the person skilled in the art and which is equivalent to a CMOS or CCD image sensor for detecting an image. As a result, the photodetector element can be embodied particularly advantageously, in particular an advantageously high spatial resolution can be achieved with the photodetector element.

Moreover, it is proposed that at least one photodetector element of the sensor device embodied as an image sensor element is embodied to be free of optical filters, in particular free of a UV filter and/or IF filter. As a result, the photodetector element embodied as an image sensor element can be embodied particularly advantageously for determining at least one food parameter by means of the food inspection device.

Furthermore, it is proposed that the food inspection device comprises at least one computing unit, which is provided to determine, by processing at least one item of sensor information from a detection range, a food parameter of a food arranged in a detection range. A “computing unit” should be understood in particular to mean a unit with an information input, information processing and an information output. The computing unit advantageously has at least one processor, a storage unit, input and output means, further electric components, an operating program, regulation routines, control routines and/or calculation routines. The components of the computing unit are preferably arranged on a shared printed circuit board and/or advantageously in a shared housing. An “item of sensor information” should in particular be understood here to mean an item of sensor information output by the sensor device, which contains at least one item of information about a wavelength and an intensity of electromagnetic radiation in the detection range. The sensor information is preferably embodied as an item of image information which has in particular image information about the entire detection range. As a result, a food parameter can be determined particularly easily.

Furthermore, it is proposed that the computing unit is provided to determine at least one food parameter, in order to calculate at least two different items of image information with one another for the purpose of generating a virtual spectral profile. “Different items of image information” should in particular be understood to mean at least two items of image information, preferably in particular images which have been detected with different illuminations by means of the illumination element, in other words in particular with illuminations with electromagnetic radiations with in each case a different wavelength range. As a result, many spectra can advantageously be analyzed with few measurements using the computing unit of the food inspection device and as a result in particular a rapid and simple determination of different food parameters can take place.

Further advantages result from the following description of the drawings. An exemplary embodiment of the invention is shown in the drawing. The drawing, the description and the claims contain numerous features in combination. The person skilled in the art will expediently also consider the features individually and combine the same to form useful further combinations.

In the drawings:

FIG. 1 shows a schematic diagram of a household appliance with a household appliance device with a food inspection device,

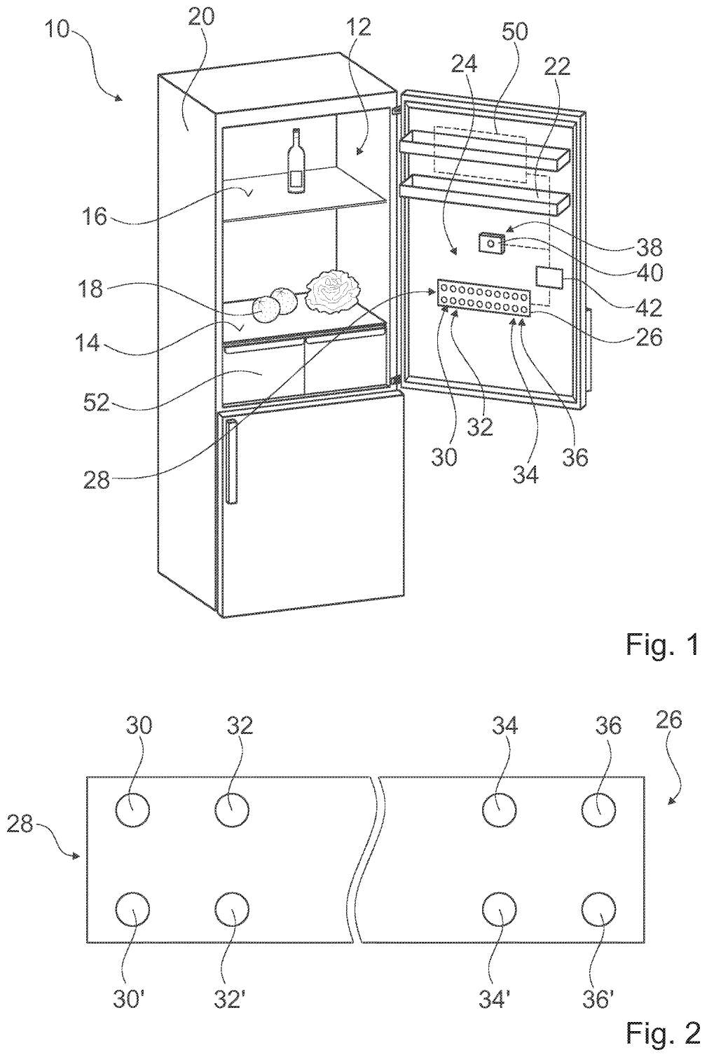

FIG. 2 shows a schematic diagram of an exposure element of the food inspection device and

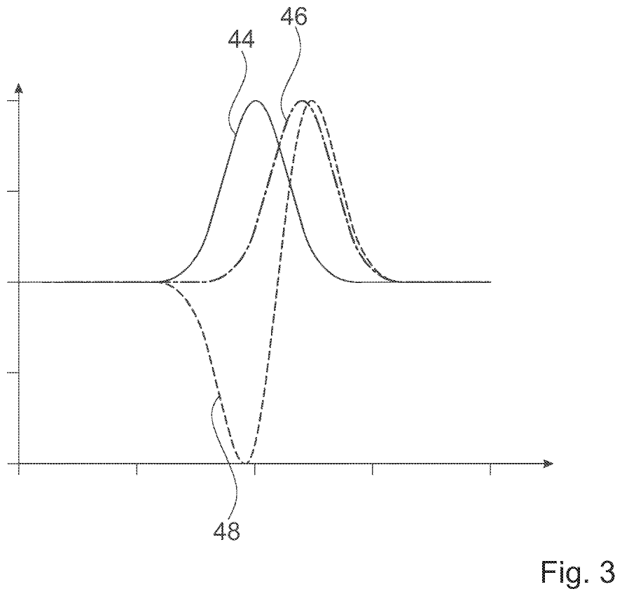

FIG. 3 shows a schematic diagram of an exemplary generation of a virtual spectrum by calculating two items of image information.

FIG. 1 shows a household appliance 10 with a household appliance device. The household appliance device is embodied as a household refrigeration appliance device. The household appliance 10 is embodied as a household refrigeration appliance. In particular, the household appliance 10 embodied as a household refrigeration appliance is embodied as a refrigerator. The household appliance device has a storage space 12. The storage space 12 is provided to be able to store food 18 therein. Here the storage space 12 is provided in particular for an advantageous storage of food 18, so that the stored food 18 advantageously ripens and/or remains fresh. The storage space 12 is embodied as a refrigeration compartment. The storage space 12 embodied as a refrigeration compartment has a temperature, during normal operation of the household appliance 10, which lies in a range between 1 degree Celsius and 18 degrees Celsius. The household appliance 10 has a refrigeration unit (not shown in more detail) for cooling the storage space 12; it is provided to regulate a temperature in the storage space 12. The storage space 12 is provided to store items, such as preferably food 18, in a cooled manner therein. A number of storage compartments 14, 16, which are arranged at different heights, are available in the storage space 12. The storage compartments 14, 16 in each case form storage areas for food 18. The household appliance 10 has a housing 20. The housing 20 delimits the storage space 12 at least essentially. The storage space 12 has an access opening through which the storage space 12 is accessible. The household appliance 10 has an appliance closing element 22. The appliance closing element 22 is provided to close the access opening and thus the storage space 12 in a closed state. In an opened state, the appliance closing element 22 releases the access opening, in other words the storage space 12. The appliance closing element 22 is embodied as a door, which is pivotably attached to the housing 20 of the household appliance 10. It is essentially also conceivable for the appliance closing element 22 to be embodied in a different manner.

The household appliance device has a food inspection device 24. The food inspection device 24 is provided to monitor food 18 arranged in the storage space 12. The food inspection device 24 is provided to assign a food 18 arranged in the storage space 12 to one category. The food inspection device 24 is in particular provided to identify at least one food 18 arranged in the storage space 12. The food inspection device 24 is provided in particular to determine a freshness of at least one food 18 arranged in the storage space 12. The food inspection device 24 is provided to determine a category and/or a freshness of a food 18 arranged in the storage space 12, in particular to determine at least one food parameter by means of a spectral analysis. The food inspection device 24 is provided to determine at least one food parameter of the food 18 by processing a spectral fingerprint of a food 18 stored in the storage space 12. The food inspection device 24 is provided by means of the spectral analysis of electromagnetic radiation reflected by the food 18, which lies in particular in a wavelength band of 250 nm to 1200 nm, to detect at least one food parameter of the food 18. By means of the spectral analysis, the food inspection device 24 can conclude both a composition of the food 18 and also substances present in the food 18. As a result, the food inspection device 24 can determine a food parameter of the food 18 which reflects a category and/or a degree of freshness of the food 18.

The food inspection device 24 comprises an illumination means 26. The illumination means 26 is provided to illuminate at least one part of the storage space 12 in order to determine a food parameter of a food 18 arranged in the storage space 12. The illumination means 26 is preferably provided in order to illuminate the entire storage space 12 in an activated state. The illumination means 26 is arranged in the storage space 12. The illumination means 26 is attached to an interior of the appliance closing element 22. It would essentially also be conceivable for the illumination means 26 to be arranged at another position within the storage space 12. It is likewise essentially conceivable for the illumination means 26 to be arranged at least partially in an inner region spanned by the appliance closing element 22 or the housing 20 and for the storage space 12 to be illuminable by means of a transparent separating element. It is essentially also conceivable for the food inspection device 24 to have a number of illuminations means 26, which are arranged at different positions in the storage space 12. The illumination means 26 is provided for a wavelength-selective illumination of the storage space 12. The illumination means 26 is provided to output electromagnetic radiation in a wavelength range of 400 nm to 1100 nm. The illumination means 26 is provided for the wavelength-selective illumination of a food 18 to be inspected. The illumination means 26 is provided for a wavelength-selective illumination, in order, in an illumination period, to output electromagnetic radiation in a wavelength band of 20 nm. With the wavelength-selective illumination, the illumination means 26 is provided in order to output electromagnetic radiation with a wavelength band of 20 nm from the entire possible wavelength range of 400 nm to 1100 nm, in other words for instance electromagnetic radiation with a wavelength band of 400 nm to 420 nm. The illumination means 26 is provided during the wavelength-selective illumination in particular to output different electromagnetic radiation with a wavelength band of 20 nm in each case in different illumination periods. By means of the wavelength-selective illumination using the illumination means 26, the food inspection device 24 is provided to carry out the spectral analysis of the food 18.

The illumination means 26 has a number of LEDs 30, 30′, 32, 32′, 34, 34′, 36, 36′ arranged in an array 28. For the sake of clarity, only the eight LEDs 30, 30′, 32, 32′, 34, 34′, 36, 36′ are shown in more detail in the Figures. The LEDs 30, 30′, 32, 32′, 34, 34′, 36, 36′ of the illumination means 26 are provided to output electromagnetic radiation in a wavelength band of 400 nm to 1100 nm. The LEDs 30, 30′, 32, 32′, 34, 34′, 36, 36′ of the illumination means 26 are provided in each case to output electromagnetic radiation with an emission spectrum of 20 nm. Two LEDs 30, 30′, 32, 32′, 34, 34′, 36, 36′ which are adjacent in respect of their wavelength range have a wavelength spacing of 20 nm. The wavelength spacing between two adjacent LEDs 30, 30′, 32, 32′, 34, 34′, 36, 36′ is measured here by the peak wavelength of the one LEDs 30, 30′, 32, 32′, 34, 34′, 36, 36′ to the peak wavelength of the other LEDs 30, 30′, 32, 32′, 34, 34′, 36, 36′. With two LEDs 30, 30′, 32, 32′, 34, 34′, 36, 36′ which are adjacent in terms of their wavelength range, the electromagnetic radiation of the one LEDs 30, 30′, 34, 34′ has a maximum wavelength which corresponds to a minimum wavelength of the electromagnetic radiation of the other LEDs 32, 32′, 36, 36′. The LEDs 30, 30′, 32, 32′, 34, 34′, 36, 36′ of the illumination means 26 can be controlled independently of one another.

An embodiment of the illumination means 26 is described by way of example below. The illumination means 26 has 70 LEDs 30, 30′, 32, 32′, 34, 34′, 36, 36′ . Two of the LEDs 30, 30′, 32, 32′, 34, 34′, 36, 36′ of the illumination means 26 are embodied to be identical in each case. Two LEDs 30, 30′, 32, 32′, 34, 34′, 36, 36′ of the illumination means 26 have in particular an identical emission spectrum of their electromagnetic radiation. As a result, improved illumination can be achieved in the storage space 12. Essentially it is also conceivable for the illumination means 26 to have in each case more than two LEDs 30, 30′, 32, 32′, 34, 34′, 36, 36′ with the identical emission spectrum. The LEDs 30, 30′ are provided to emit electromagnetic radiation with a wavelength band of 400 nm to 420 nm. The peak wavelength of the LEDs 30, 30′ is at 410 nm. The adjacently arranged LEDs 32, 32′ are provided to emit electromagnetic radiation with a wavelength band of 420 nm to 440 nm. The peak wavelength of the LEDs 32, 32′ is at 430 nm. The LEDs 30, 30′ and the LEDs 32, 32′ are arranged in this example adjacent to one another both in terms of wavelength range and also in terms of position. It would essentially also be conceivable for the LEDs 30, 30′ and the LEDs 32, 32′ to be arranged spatially separated from one another. It is essentially likewise conceivable for the LEDs 30, 30′ or the LEDs 32, 32′ which have the identical emission spectrum to be separated spatially from one another and in particular not arranged adjacent to one another. The LEDs 34, 34′ are provided to emit electromagnetic radiation with a wavelength band of 1060 nm to 1080 nm. The peak wavelength of the LEDs 34, 34′ is 1070 nm. The adjacently arranged LEDs 36, 36′ are provided to emit electromagnetic radiation with a wavelength band of 1080 nm to 1100 nm. The peak wavelength of the LEDs 36, 36′ is 1090 nm. In this example the LEDs 34, 34′ and the LEDs 36, 36′ are arranged adjacent to one another both in terms of wavelength range and also in terms of position. It would essentially also be conceivable for the LEDs 34, 34′ and the LEDs 36, 36′ to be arranged separated spatially from one another. It is essentially likewise conceivable for the LEDs 34, 34′ or the LEDs 36, 36′ which have the identical emission spectrum to be separated spatially from one another and in particular not arranged adjacent to one another. The LEDs 30, 30′, 32, 32′, 34, 34′, 36, 36′ of the illumination means 26 can be controlled independently of one another. The LEDs 30, 30′, 32, 32′, 34, 34′, 36, 36′, at least the LEDs 30, 30′, 32, 32′, 34, 34′ 36, 36′, which have the same emission spectrum, can be switched on and off separately. Therefore electromagnetic radiation can be generated in a wavelength range of 400 nm to 1100 nm with a resolution of 20 nm by means of the LEDs 30, 30′, 32, 32′, 34, 34′, 36, 36′ of the illumination means 26.

The food inspection device 24 has a sensor device 38. The sensor device 38 is provided, in order to determine at least one food parameter of a food 18 arranged in the storage space 12, to detect at least one physical variable output by the food 18. The sensor device 38 comprises a photodetector element 40. The photodetector element 40 is provided to receive electromagnetic radiation from a detection range, which is arranged in particular in the storage space 12. The photodetector element 40 is embodied in particular as an image sensor element. The photodetector element 40 is embodied as an optical sensor which has a recording spectrum in a wavelength range of approx. 350 nm to 1100 nm. The photodetector element 40 is in particular embodied as a CMOS or a CCD sensor known from the prior art. The photodetector element 40 which is embodied as an image sensor element is embodied free of optical filters. In particular, the photodetector element 40 embodied as an image sensor element has no UV filter and no IF filter. The photodetector element 40 embodied as an image sensor element is provided to detect at least one image. The photodetector element 40 embodied as an image sensor element is provided to produce an image of a detection range and to output the corresponding image information electronically as a sensor signal. The photodetector element 40 embodied as an image sensor element is designed so that its detection range is arranged in the storage space 12. The detection range of the photodetector element 40 embodied as an image sensor element extends here in the storage space 12 at least across a storage area for food 18 which is embodied by a storage compartment 14. Essentially it would also be conceivable for the detection range of the photodetector element 40 embodied as an image sensor element to extend across a range of a number of storage compartments 14, 16 or across the entire storage space 12. It would likewise be conceivable for the illumination means 26 and the photodetector element 40 embodied as an image sensor element to be arranged in a separate compartment, like for instance a vegetable compartment 52 of the household appliance 10, and for the detection range of the photodetector element 40 embodied as an image sensor element to comprise an inner region of the vegetable compartment 52.

It is essentially also conceivable for the sensor device 38 to have a number of photodetector elements 40, in particular a number of photodetector elements 40 embodied as an image sensor element, which have different detection ranges which detect different regions in the storage space 12, for instance different storage compartments 14, 16.

The food inspection device 24 comprises a computing unit 42. The computing unit 42 is provided to determine at least one food parameter of the food 18 in order to process a sensor signal output by the photodetector element 40. The computing unit 42 is provided in particular to determine at least one food parameter of the food 18 in order to process an image detected by the photodetector element 40 embodied as an image sensor element. The computing unit 42 is provided to determine at least one food parameter of the food 18 so as to evaluate image information or images detected by the photodetector element 40 during exposure to electromagnetic radiation with different wavelength ranges. On the basis of an intensity of the electromagnetic radiation in different wavelength ranges, the computing unit 42 is provided so as to produce a spectrum characteristic of the food 18. The computing unit 42 has an internal storage device, on which reference spectra for different food 18 are stored in different degrees of ripeness and/or freshness. The computing unit 42 is provided to assign a corresponding reference spectrum to the determined characteristic spectrum of the food 18 in order thus to determine the corresponding food parameters of the food 18. It is essentially also conceivable for parts of the computing unit 42 or its functions and/or data records, like for instance reference spectra, to be stored at least partially on an external computing unit, for instance in a cloud.

The computing unit 42 is provided to determine the at least one food parameter of the food 18 in order to calculate at least two different items of image information 44, 46 so as to generate a virtual spectral profile. The computing unit 42 is provided in particular to calculate two images or items of image information 44, 46 detected by the photodetector element during illuminations with electromagnetic radiations with different wavelength bands. A virtual spectrum can be generated as a result and further items of spectral information can be provided so as to determine a food parameter. By way of example, FIG. 3 shows one such generation of a virtual spectrum by calculating two items of image information 44, 46, which have been captured with different illuminations. A first item of image information 44, which is recorded with an illumination with electromagnetic radiation of 1000 nm peak wavelength, is calculated with a second item of image information 46, which is recorded with an illumination with electromagnetic radiation of 1020 nm peak wavelength, in order to form an item of differential image information 48. The two recorded items of image information 44, 46 of the two different illuminations have a Gaussian-type brightness profile with a specific overlap. A new, virtual spectral profile is generated by the formation of the differential image information 48. Thus generated differential image information 48 can be used as additional spectral information for identifying ingredients in a food 18, in other words for determining food parameters. It is essentially also conceivable for the computing unit 42 to be provided to form other combinations so as to generate a virtual spectral profile. It is therefore conceivable for instance for a virtual spectral profile to be generated in the form of |=Σai*li, wherein li represents an item of image information during an illumination with electromagnetic radiation with a specific peak wavelength and ai represents a positive or negative weighting factor.

The food inspection device 24 comprises an output unit 50. The output unit 50 is embodied as a display element which is arranged on an exterior of the household appliance 10. The output unit 50 is provided so that the at least one food parameter of the food 18 can be indicated to a user. It is conceivable for the output unit 50 to directly output a corresponding food parameter embodied for instance as a degree of freshness after a food inspection using the food inspection device 24 triggered by a user. It is essentially also conceivable for the food inspection device 24 to automatically output a notification by means of the output unit 50 to a user in the case of a detected food parameter which indicates that the food 18 has perished. It is essentially also conceivable for the food inspection device 24 to be provided so as to convey a determined food parameter to an external device.

A method for determining at least one food parameter of a food 18 arranged in the household appliance 10 is to be described in brief below. A food parameter of the food 18, which can be determined by means of the food inspection device 24, is embodied as a degree of freshness or as a category of food. A determination of a food parameter of the food 18 is carried out in a state in which the storage space 12 of the household appliance 10 is closed by the appliance closing element 22. As a result, no light in particular is advantageously able to penetrate the household appliance 10, in particular the storage space 12, from the outside during a determination of a food parameter. This can rule out electromagnetic radiation output by the illumination means 26 being contaminated by ambient light. In order to determine the food parameter, the storage space 12, in particular the food 18 to be examined, is illuminated in a wavelength-selective manner by the illumination means 26. To this end, the illumination means 26 illuminates the food 18 at different illumination times, preferably directly consecutively, with electromagnetic radiation which has different wavelengths, in particular different peak wavelengths. An item of image information, preferably an image of the detection range of the photodetector element 40, is detected at each illumination time using the photodetector element 40. So many illuminations with an emission spectrum of 20 nm and image information corresponding to the photodetector element 40 are preferably detected by means of the illumination means 26 that at least a large part, preferably the entire wavelength range of 350 nm to 1100 nm is covered. In addition, further virtual spectra can also be generated by calculating different items of image information and used to determine a food parameter.

### REFERENCE CHARACTERS

10 household appliance
12 storage space
14 storage compartment
16 storage compartment
18 food
20 housing
22 appliance closing element
24 food inspection device
26 illumination means
28 array
30 LED
32 LED
34 LED
36 LED
38 sensor device
40 photodetector element
42 computing unit
44 image information
46 image information
48 differential image sensor
50 output unit
52 vegetable compartment

1-14. (canceled)

15. A household appliance device or household refrigeration appliance device, comprising:
at least one storage space;
at least one food inspection device for determining at least one food parameter of at least one item of food disposed in said at least one storage space at least by spectral analysis;
said at least one food inspection device including at least one illumination device for at least determining the at least one food parameter and illuminating at least part of said at least one storage space;
said at least one food inspection device using at least a wavelength-selective illumination provided by said at least one illumination device to carry out a spectral analysis of the at least one item of food; and
said at least one illumination device having a plurality of LEDs disposed in an array and acting together to output electromagnetic radiation in a wavelength band of 250 nm to 1200 nm.

16. The household appliance device according to claim 15, wherein said at least one food inspection device determines said at least one food parameter by using said at least one illumination device at least to illuminate with electromagnetic radiation in a defined wavelength band of at most 100 nm in at least one exposure period.

17. The household appliance device according to claim 15, wherein said at least one illumination device has at least two LEDs disposed in said array.

18. The household appliance device according to claim 15, wherein each of said plurality of LEDs disposed in said array in said at least one illumination device is configured to emit electromagnetic radiation with an emission spectrum of at most 50 nm.

19. The household appliance device according to claim 15, wherein each of said plurality of LEDs disposed in said array in said at least one illumination device is configured to be controlled at least partially independently of one another.

20. The household appliance device according to claim 15, wherein two of said plurality of LEDs disposed in said array in said at least one illumination device are mutually adjacent in terms of wavelength and have a wavelength spacing of at most 100 nm.

21. The household appliance device according to claim 15, wherein said at least one food inspection device includes at least one sensor device having at least one photodetector element for at least determining a food parameter in order to record at least one electromagnetic radiation from a detection range in said at least one storage space.

22. The household appliance device according to claim 21, wherein said at least one photodetector element is an image sensor element for at least detecting at least one image.

23. The household appliance device according to claim 22, wherein said image sensor element of said at least one sensor device of said at least one photodetector element is free of optical filters.

24. The household appliance device according to claim 22, wherein said image sensor element of said at least one sensor device of said at least one photodetector element is free of at least one of UV or IF filters.

25. The household appliance device according to claim 15, wherein said at least one food inspection device includes at least one computing unit for determining a food parameter of the at least one item of food disposed in a detection range by processing at least one item of sensor information from the detection range.

26. The household appliance device according to claim 25, wherein said computing unit determines the at least one food parameter for calculating at least two different items of image information to generate a virtual spectral profile.

27. A household appliance, comprising at least one household appliance device according to claim 15.

28. A food inspection device for a household appliance device according to claim 15.

29. A method of operating a household appliance device or household refrigeration appliance device having at least one storage space, the method comprising the following steps:
providing at least one food inspection device including at least one illumination device having a plurality of LEDs disposed in an array;
using the at least one food inspection device to determine a food parameter of at least one item of food at least by spectral analysis;
using the at least one illumination device to illuminate the at least one item of food to at least determine the food parameter;
using the at least one food inspection device to carry out a spectral analysis of the at least one item of food at least by a wavelength-selective illumination by using the at least one illumination device; and
using the plurality of LEDs together to output electromagnetic radiation in a wavelength band of 250 nm to 1200 nm.
